(19) United States
(12) Patent Application Publication
(10) Pub. No.: US 2023/0228638 A1
(43) Pub. Date: Jul. 20, 2023

(54) Sensor, Arrangement, Use, Method of Estimating an Angle of Attack, and Computer Readable Memory

(71) Applicant: Teknologian tutkimuskeskus VTT Oy, Espoo (FI)

(72) Inventors: Jennifer CARREIRO SPENCER, Espoo (FI); Raul PRIETO, Espoo (FI)

(21) Appl. No.: 17/923,243

(22) PCT Filed: May 20, 2021
(86) PCT No.: PCT/FI2021/050365

§ 371 Date: Nov. 4, 2022

(30) Foreign Application Priority Data
May 20, 2020 (FI) 20205516

(51) Int. Cl. G01L 11/02; G01P 13/02; F03D 7/04

(52) U.S. Cl. CPC G01L 11/025; G01P 13/025; F03D 7/042; F03D 7/0224

(57) ABSTRACT

According to an example aspect of the present invention, there is provided a sensor comprising at least one strut configured to be coupled to a surface of an object at a first end of the strut, a structure connected to a second end of the at least one strut, wherein the structure is V-shaped, U-shaped, curved or arched and configured to be coupled to the surface at both ends, a plurality of cavities positioned along the structure on both sides of the at least one strut, and a plurality of fibre-optic pressure transducers, wherein a single fibre-optic pressure transducer is arranged within each of the cavities, and wherein the sensor is configured such that at least some of the fibre-optic pressure transducers are arranged at different distances from the surface of the object.

### FIELD

The present invention relates to a sensor. In particular, certain embodiments of the present invention relate to a flow sensor.

Further, the present invention relates to an arrangement comprising at least a first sensor and a second sensor and a blade, for example a wind turbine blade.

Yet further, the present invention relates to a use of a sensor.

Furthermore, the present invention relates to a method of estimating an angle of attack.

Additionally, the present invention relates to a computer readable memory.

### BACKGROUND

In the operation of wind turbine blades, it is advantageous to reduce the fluctuation of the load generated by the wind acting on the wind turbine blades. In order to reduce said fluctuation, known applications include measurement of blade root strains in the structure, and subsequently adjust the incidence of the blades in order to control said strains. A set of strain gauge sensors is placed near the root of the blades. These sensors then measure the aerodynamic loading on the blades, which is then fed to the pitch control system of the wind turbine. This form of measurement implies that the turbine blades suffer from the aerodynamic loads before the wind turbine is capable of reacting to them.

Documents WO 2019/129337 A1 and US 2018/0335015 A1 further disclose methods comprising placing of sensors radially along the blade measuring the deflection between an inboard and an outboard location. Document U.S. Pat. No. 7,445,431 B2 even further describes measuring the angle of attack by using pitot tubes, five-hole probes, or cobra probes. Said sensors require frequent maintenance and are not suited to the operating condition of a wind turbine blade due to the exposure to weather, rain, icing, and potential clogging of the duct between the inlet tube and the transducer. Documents US 2014/0356165 A1 and US 2010/0021296 A1 yet further teach a configuration of air pressure sensors embedded along a blade profile. In other words, a high number of sensors is directly integrated into the blade surface. Document U.S. Pat. No. 8,397,564 B2 furthermore discloses a system including a strain gauge connected to a flexible component which separates from the blade surface when the flow surrounding the sensor is in a separated state. Such a sensor provides a reading on whether the flow is separated or not, but not a precise indication of the angle of attack. Additionally, document U.S. Pat. No. 8,712,703 B2 describes a turbulence sensor system comprising light sensors embedded in cavities along the blade to measure deformations in a surface membrane. Document U.S. Pat. No. 9,753,050 B2 teaches a method comprising measuring the deflection of a protruding optic fibre sensor and relating the amount of bending of said fibre to the air flow speed. Additionally, document U.S. Pat. No. 8,915,709 B2 describes the computation of an angle of attack by using an optical LIDAR sensor. This solution has the complexity of embedding electrically powered equipment in the outer part of the blade, thus leaving it susceptible to lightning strike.

In view of the foregoing, it would be beneficial to provide a sensor for estimating an angle of attack of a wind turbine blade at a specific radial position in real time. The sensor should not be susceptible to lightning strike. The sensor should be capable of being manufactured on an industrial scale.

### SUMMARY OF THE INVENTION

The invention is defined by the features of the independent claims. Some specific embodiments are defined in the dependent claims.

According to a first aspect of the present invention, there is provided a sensor comprising at least one strut configured to be coupled to a surface of an object at a first end of the strut, a structure connected to a second end of the at least one strut, wherein the structure is V-shaped, U shaped, curved or arched and configured to be coupled to the surface at both of its ends, a plurality of cavities positioned along the structure on both sides of the at least one strut, and a plurality of fibre-optic pressure transducers, wherein a single fibre-optic pressure transducer is arranged within each of the cavities, and wherein the sensor is configured such that at least some of the fibre-optic pressure transducers are arranged at different distances from the surface of the object.

Various embodiments of the first aspect may comprise at least one feature from the following bulleted list:
the structure is configured such that at least some of the cavities are arranged at different distances from the surface of the object
the sensor is configured to measure a stagnation pressure of an incident air flow at different distances from the surface of the object
the structure is symmetrical or asymmetrical
at least a section of the structure is in the form of an aerodynamic profile, an airfoil or a NACA airfoil
at least some of the cavities extend through a leading edge of the structure in the form of an aerodynamic profile, an airfoil or a NACA airfoil
at least a section of the at least one strut is in the form of an aerodynamic profile, an airfoil or a NACA airfoil
the structure is shaped symmetrically
the second end of the at least one strut is connected to a center of the structure
the sensor further comprises a microprocessor
the sensor comprises a transmitter configured to wirelessly transmit data to a node
the cavity comprises at least one separating wall
the number of cavities on a first side of the at least one strut is different than the number of cavities on a second side of the at least one strut
the sensor comprises two or more struts
each fibre-optic pressure transducer is placed in a cavity in a wall substantially aligned with an incident flow
the at least one strut comprises further fibre-optic pressure transducers arranged at different distances from the surface of the object

According to a second aspect of the present invention, there is provided an arrangement comprising at least a first sensor according to any one of claims 1-11 and a second sensor according to any one of claims 1-11, at least one blade, wherein the first sensor is coupled to a pressure side of the at least one blade and the second sensor is coupled to a suction side of the at least one blade.

Various embodiments of the second aspect may comprise at least one feature from the following bulleted list:
the arrangement is configured to estimate an angle of attack of the at least one blade based on an angle of attack estimator
the arrangement further comprises a microprocessor configured to estimate an angle of attack of the at least one blade based on an angle of attack estimator
the microprocessor is configured to calculate a first height HPS above the pressure side surface of the at least one blade and a second height HSS above the suction side surface of the at least one blade, where the total pressure is below a threshold value
the microprocessor is further configured to estimate an angle of attack of the at least one blade based on a ratio HSS/(HSS+HPS)
the arrangement is configured to estimate an angle of attack based on pattern recognition applied to pressure readings of the first sensor and the second sensor the arrangement is configured to estimate an angle of attack using a neural network
the at least one blade is a blade of a wind turbine
the arrangement further comprises a transmitter configured to wirelessly transmit the estimated angle of attack to a pitch control system or a computing device

According to a third aspect of the present invention, there is provided a use of a sensor according to any one of claims 1-7 in connection with a wind turbine blade, an aircraft wing, a wing, a blade or an object.

According to a fourth aspect of the present invention, there is provided a method for estimating an angle of attack of at least one blade, the method comprising providing a first sensor according to any one of claims 1-11 on a pressure side surface of a blade, providing a second sensor according to any one of claims 1-11 on a suction side surface of the blade, and calculating an angle of attack of the blade based on an angle of attack estimator.

Various embodiments of the fourth aspect may comprise at least one feature from the following bulleted list:
calculating a by a microprocessor first height HPS above the pressure side surface of the wind turbine blade and a second height HSS above the suction side surface of the wind turbine blade, where the total pressure is below a threshold value
estimating by the microprocessor an angle of attack of the wind turbine blade based on a ratio HSS/(HSS+HPS)
estimating an angle of attack based on pattern recognition applied to pressure readings of the first sensor and the second sensor using a neural network in order to estimate an angle of attack of the wind turbine blade

According to a fifth aspect of the present invention, there is provided a non-transitory computer readable memory having stored thereon a set of computer implementable instructions capable of causing a computing device, in connection with a wind turbine, at least to receive from a first sensor according to any one of claims 1-11 information about a stagnation pressure of an incident air flow at different distances from a pressure side surface of a wind turbine blade, receive from a second sensor according to any one of claims 1-11 information about a stagnation pressure of an incident air flow at different distances from a suction side surface of the wind turbine blade, calculate an angle of attack of the wind turbine blade based on an angle of attack estimator, and control a pitch angle of the wind turbine blade based on the calculated angle of attack.

Various embodiments of the fifth aspect may comprise at least one feature from the following bulleted list:
calculate a first height HPS above the pressure side surface of the wind turbine blade and a second height HSS above the suction side surface of the wind turbine blade, where the total pressure is below a threshold value
estimate an angle of attack of the wind turbine blade based on a ratio HSS/(HSS+HPS)
estimate an angle of attack based on pattern recognition applied to pressure readings of the first sensor and the second sensor
use of a neural network in order to estimate an angle of attack of the wind turbine blade
the first sensor is a sensor in accordance with any one of claims 1-7 the second sensor is a sensor in accordance with any one of claims 1-7

Considerable advantages are obtained by means of certain embodiments of the present invention. A sensor system and a method for estimating an angle of attack are provided. According to certain embodiments of the present invention, an angle of attack of a wind turbine blade at a specific radial station can be estimated. Estimation of the angle of attack takes place in real time. Having reliable information on the aerodynamics affecting the rotor enables the deployment of more advanced wind turbine control, reducing fatigue loads and noise, reducing weight and material costs, and increasing efficiency and energy yield. The sensor system, which measures the wind aerodynamic flow condition, which generates the aerodynamic load directly at blade outboard locations, represents a significant improvement over a blade root measurement. Knowing the angle of attack and sensing the flow affecting the blade in the outer part of the blade has the advantage of allowing faster reaction to wind variation, as compared to current state of the art blade root measurement sensors. Thus, the angle of attack sensor allows improved control of a wind turbine. Advantageously, the angle of attack is estimated without the need of knowing the upstream wind speed relative to the airfoil to within an accuracy of better than +/−0.5 degrees.

Advantageously, the magnitude of surface contamination due to roughness, erosion, bugs, debris or icing can be further found from the total pressure readings using the ratio HSS/(HSS+HPS) and the magnitude HSS+HPS. Alternatively, pattern recognition with neural networks may also be used for estimating the magnitude of surface contamination.

The system further relies on a reliable and robust fibre-optic sensor system. Fibre-optic based sensors are not affected by lightning strike, which is common on wind turbines.

Due to the V-shaped, U-shaped, curved or arched structure of the sensor system, the maximum number of pressure transducers can be increased in comparison to a sensor in the form of a mere pile. Thus, more pressure transducers for different heights from the surface of the object can be provided. Consequently, measurement results can be improved by use of a sensor system according to embodiments of the invention. Alternatively or in addition, redundant measurements may be possible according to certain embodiments of the present invention.

### BRIEF DESCRIPTION OF THE DRAWINGS

FIG. 1 illustrates a schematic perspective view of a sensor in accordance with at least some embodiments of the present invention,

FIG. 2 illustrates a schematic front view of a sensor in accordance with at least some embodiments of the present invention,

FIG. 3 illustrates a schematic front view of a detail of a sensor in accordance with at least some embodiments of the present invention,

FIG. 4 illustrates a schematic front view of another detail of a sensor in accordance with at least some embodiments of the present invention,

FIG. 5 illustrates a schematic perspective view of an arrangement in accordance with at least some embodiments of the present invention, and

FIG. 6 illustrates a schematic front view of another arrangement in accordance with at least some embodiments of the present invention.

### EMBODIMENTS

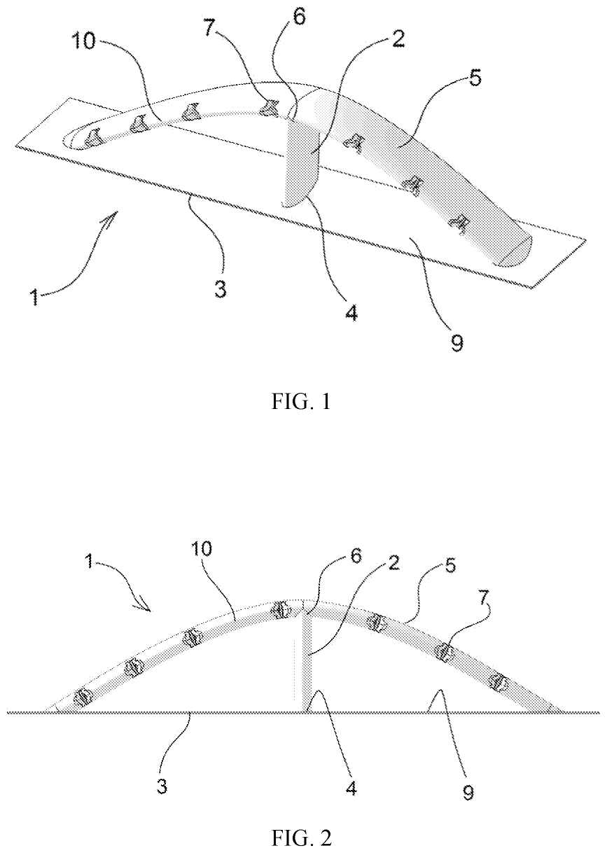

In FIG. 1, a schematic perspective view of a sensor 1 in accordance with at least some embodiments of the present invention is illustrated. The sensor 1 comprises a strut 2 configured to be coupled to a surface 9 of an object 3 at a first end 4 of the strut 2. The strut 2 may be in the form of a profile or in the form of a NACA airfoil, for instance. The object 3 may be, for example, a blade of a wind turbine.

Further, the sensor 1 comprises a structure 5 connected to a second end 6 of the strut 2. The structure 5 is typically V-shaped, U shaped, curved or arched. Typically, at least a section of the structure 5 is in the form of a profile or in the form of a NACA airfoil. The structure 5 may be, for example, shaped symmetrically and the strut 2 may be connected at its second end 6 to a centre of the structure 5. A plurality of cavities 7 are positioned along the structure 5. Typically, at least some of the cavities 7 extend through a leading edge 10 of the structure 5 in the form of an aerodynamic profile, airfoil or a NACA airfoil. Of course, also two or more struts 2 may be provided, wherein each strut 2 is connected at its second end 6 to the structure 5. NACA airfoils are commonly known and have been widely studied by the National Advisory Committee for Aeronautics.

In other words, the structure 5 typically has a curved or arched wing profile and an aerodynamically faired strut 2 to reduce the drag. Said form further prevents the possibility of accidental damage from maintenance crew, ropes, or icing as compared to a protruding pole.

Additionally, the sensor 1 comprises a plurality of fibre-optic pressure transducers 8. A single fibre-optic pressure transducer 8 is arranged within each of the cavities 7. The sensor 1 is configured such that at least some of the fibre-optic pressure transducers 8 are arranged at different distances from the surface 9 of the object 3. In other words, also at least some of the cavities 7 are arranged at different distances from the surface 9 of the object 3. Thus, the shown sensor 1 is capable of measuring a stagnation pressure of an incident air flow at different distances from the surface 9 of the object 3.

In FIG. 2, a schematic front view of a sensor 1 in accordance with at least some embodiments of the present invention is illustrated. It can be seen that the strut 2 is connected to the centre of the structure 5 at the second end 6 of the strut 2. The first end 4 of the strut is coupled to a surface 9 of an object. The structure 5 is curved or arched. The structure 5 is further symmetric. The ends of the structure 5 may be, for example, coupled to the surface 9. A plurality of cavities 7 is provided along a leading edge 10 of the structure 5. Each cavity 7 is arranged at a different distance from the surface 9. The number of cavities can be, but not necessarily, different on both sides of the strut 2.

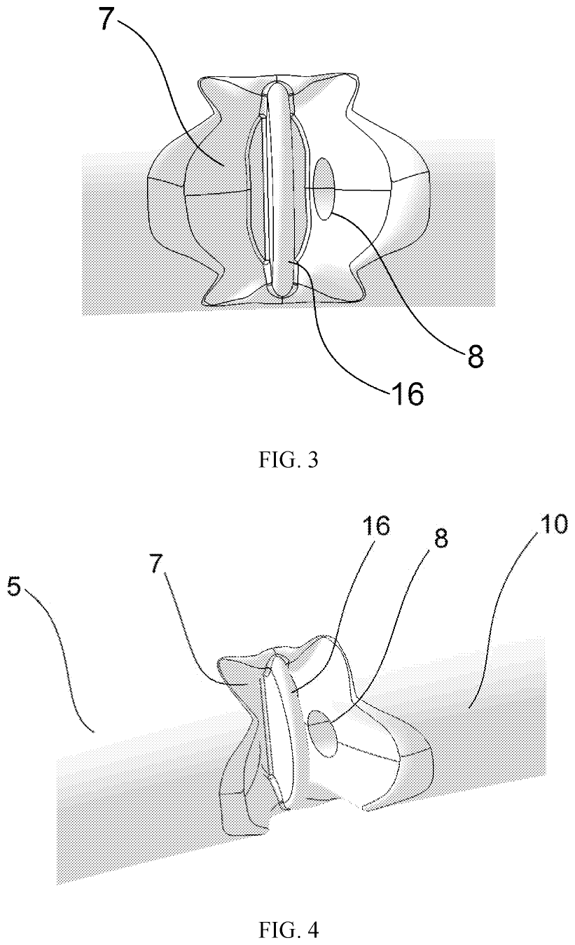

In FIG. 3, a schematic front view of a detail of a sensor in accordance with at least some embodiments of the present invention is illustrated. A particular shape of a cavity 7 or chamber is shown. The cavity has been designed using CFD (computer aided fluid design) simulation tools. A fibre-optic pressure transducer 8 is arranged within the cavity 7. Advantageously, the fibre-optic pressure transducer may be placed in the cavity in a wall substantially aligned with the incident flow to minimize any damage from direct impact of particles. The geometry of the cavity 7 is designed taking into account the noise emittance to avoid audible acoustic resonance of the cavity. Advantageously, the cavity 7 may contain one or more separating wall(s) 16 to divide the chamber into two or more volumes such as to create a stable flow structure, and consequently, provide a stable pressure reading.

In FIG. 4, a schematic front view of another detail of a sensor in accordance with at least some embodiments of the present invention is illustrated. The cavity 7 extends through a leading edge 10 of the structure 5. A fibre-optic pressure transducer 8 is arranged within the cavity 7. Advantageously, one or more drainage channel(s) provide a natural exit for the air flow to leave the cavity 7 and to contribute to a stable flow structure.

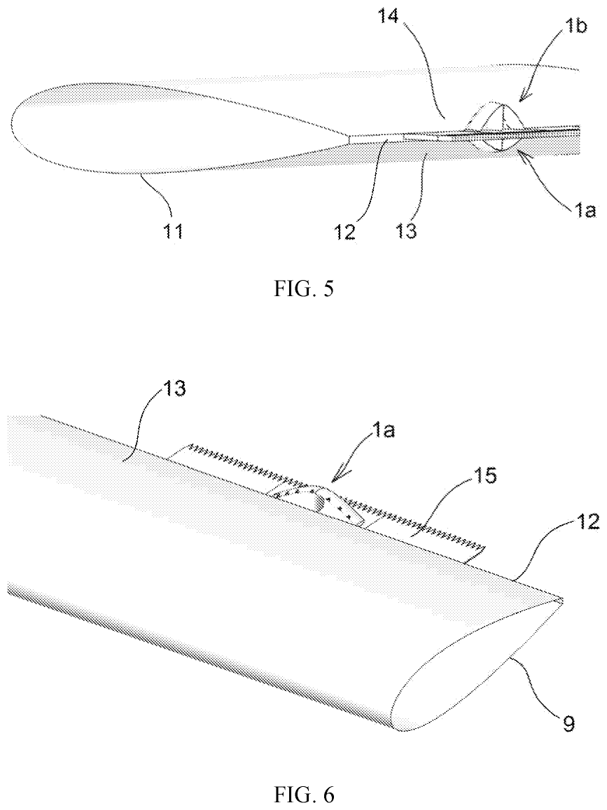

In FIG. 5, a schematic perspective view of an arrangement in accordance with at least some embodiments of the present invention is illustrated. The arrangement comprises a blade 11, for example a blade of a wind turbine. On an aerodynamic profile, the boundary layer is a section of the flow where viscous forces dominate close to the surface. The influence of the viscous forces causes flow retardation. For an airfoil section, an increase in the angle of attack leads to an increment in the boundary layer thickness along the suction side of the airfoil and to a decline in the thickness along the pressure side. However, the total thickness, including both suction and pressure sides, still tends to grow with increasing angle of attack. The thickness of the boundary layer is also dependent on the Reynolds number. Higher Reynolds numbers have the effect of decreasing the total boundary layer thickness. The boundary layer has also a relation to the roughness degree of the surface. For a given airfoil roughness condition, the thickness of both suction and pressure sides' increases with angle of attack. On the other hand, the growth of the boundary layer is considerably more prominent for the suction side and becomes much more sizeable with higher angles of attack. The total boundary layer thickness over an airfoil section with a degree of roughness is enlarged compared to that with a smooth condition. With increasing Reynolds number, this increment becomes more significant.

The arrangement comprises a first sensor 1a as e.g. described in connection with FIG. 1 and a second sensor 1b as e.g. described in connection with FIG. 1. The first sensor 1a is coupled to a pressure side of the blade 11 and the second sensor 1b is coupled to a suction side of the blade 11. As can be seen, the struts 2 of the first sensor 1a and the second sensor 1b point in opposite directions.

Additionally, the arrangement is configured to estimate an angle of attack of the blade based on an angle of attack estimator. For example, the arrangement comprises a microprocessor (not shown). The microprocessor is configured to calculate a first height HPS above the pressure side surface 13 of the blade 11 and to calculate a second height HSS above the suction side surface 14 of the blade. The first height HPS and the second height HSS are calculated, where the total pressure is below a threshold value. The microprocessor is further configured to estimate an angle of attack of the at least one blade based on a ratio HSS/(HSS+HPS).

In other words, an array of fibre-optic pressure transducers 8 measuring the stagnation pressure of an incident air flow at different heights from the surface of the blade 11 is provided in order to obtain a reading of the blade boundary layer. Such a measurement takes place on the pressure side of the blade 11 and on the suction side of the blade 11 at substantially the same radial station. Typically, the first sensor 1a and the second sensor 1b are arranged between the end of the blade 11 and 50% of the length of the blade 11, for example at 66% or 70% of the length of the blade 11. Typically, measurement is performed in the proximity of the trailing edge 12 of the blade 11. Fibre-optic pressure transducers 8 are selected to avoid susceptibility to lightning strike.

The microprocessor is capable of analysing in real time or substantially in real time, i.e. within a delay of less than 0.1 s, the measured signals from the array of fibre-optic pressure transducers 8 in order to map the measured magnitudes to an estimated angle of attack. The height HSS and HPS above the surface of respectively the suction side and the pressure side of the blade 11, where the total pressure falls below a certain threshold, are computed. Without loss of generality the threshold may be set to 99% of the free stream total pressure.

The free stream total pressure is defined as the value of total pressure in a region at a large enough distance from the blade surface so as to not be disturbed by the boundary layer viscous effects.

The height of the pressure side, HPS, is defined as the distance measured from the surface at which the total pressure value is 99% of that of the free stream pressure. Similarly, the height of the suction side, HSS, is defined as the distance measured from the surface at which the value of the total pressure is found to be 99% of the free stream value.

The angle of attack AOA of the blade 11 at the radial station where the first sensor 1a and the second sensor 1b are located is estimated from the ratio HSS/(HSS+HPS), using a dataset estimated from experimental results in a wind tunnel or other means.

Advantageously, the magnitude of surface contamination due to roughness, erosion, bugs, debris or icing is found from the ratio HSS/(HSS+HPS) and the magnitude HSS+HPS.

The arrangement may further comprise transmitter configured to wirelessly transmit the estimated angle of attack to a pitch control system or a computing device. Of course, also the computing device may be configured to analyse in real time or substantially in real time the measured signals from the array of fibre-optic pressure transducers 8 in order to map the measured magnitudes to an estimated angle of attack.

In FIG. 6, a schematic front view of another arrangement in accordance with at least some embodiments of the present invention is illustrated. A first sensor 1a and a second sensor (not shown) are coupled to a trailing edge aerodynamic add-on 15, such as a serrated trailing edge, which is connected to a trailing edge 12 of a wind turbine blade 11. According to this document, the blade 11 may incorporate a trailing edge aerodynamic add-on 15. The sensors are arranged such that they are able of measuring a stagnation pressure of an incident air flow at different distances from the pressure side surface 13 and the suction side surface (not shown) of the blade, respectively. The stagnation pressure is measured directly behind the trailing edge 12 of the blade 11.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in estimating an angle of attack of a wind turbine blade.

### REFERENCE SIGNS LIST

1, 1a, 1b sensor
2 strut
3 object
4 first end
5 structure
6 second end
7 cavity
8 fibre-optic pressure transducer
9 surface
10 leading edge of structure
11 blade
12 trailing edge of blade
13 pressure side surface
14 suction side surface
15 trailing edge aerodynamic add-on
16 separating wall

### CITATION LIST

### Patent Literature

WO 2019/129337 A1
US 2018/0335015 A1
U.S. Pat. No. 7,445,431 B2
US 2014/0356165 A1
US 2010/0021296 A1
U.S. Pat. No. 8,397,564 B2
U.S. Pat. No. 8,712,703 B2
U.S. Pat. No. 9,753,050 B2
U.S. Pat. No. 8,915,709 B2

### Non Patent Literature

1. A sensor comprising:
at least one strut configured to be coupled to an outer surface of an object at a first end of the strut,
a structure connected to a second end of the at least one strut, wherein the structure is V-shaped, U-shaped, curved or arched and configured to be coupled to the outer surface at both ends,
a plurality of cavities positioned along the structure on both sides of the at least one strut, and
a plurality of fibre-optic pressure transducers, wherein a single fibre-optic pressure transducer is arranged within each of the cavities,
and wherein the sensor is configured such that at least some of the fibre-optic pressure transducers are arranged at different distances from the outer surface of the object.

2. The sensor according to claim 1, wherein the structure is configured such that at least some of the cavities are arranged at different distances from the outer surface of the object.

3. The sensor according to claim 1, wherein the sensor is configured to measure a stagnation pressure of an incident air flow at different distances from the outer surface of the object.

4. The sensor according to claim 1, wherein the structure is symmetrical or asymmetrical.

5. The sensor according to claim 1, wherein at least a section of the structure is in the form of an aerodynamic profile, an airfoil or a NACA airfoil.

6. The sensor according to claim 5, wherein at least some of the cavities extend through a leading edge of the structure in the form of the aerodynamic profile, the airfoil or the NACA airfoil.

7. The sensor according to claim 1, wherein at least a section of the at least one strut is in the form of an aerodynamic profile, an airfoil or a NACA airfoil.

8. The sensor according to claim 1, wherein the sensor further comprises a microprocessor.

9. The sensor according to claim 1, wherein the second end of the at least one strut is connected to a centre of the structure.

10. The sensor according to claim 1, wherein each fibre-optic pressure transducer is placed in a cavity in a wall substantially aligned with an incident flow.

11. The sensor according to claim 1, wherein the at least one strut comprises further fibre-optic pressure transducers arranged at different distances from the outer surface of the object.

12. An arrangement comprising:
at least a first sensor according to claim 1 and a second sensor according to claim 1, and
at least one blade, wherein the first sensor is coupled to a pressure side of the at least one blade and the second sensor is coupled to a suction side of the at least one blade.

13. The arrangement according to claim 12, further comprising a microprocessor configured to calculate an angle of attack of the at least one blade based on an angle of attack estimator.

14. The arrangement according to claim 13, wherein the microprocessor is configured to calculate a first height HPS above a pressure side surface of the at least one blade and a second height HSS above a suction side surface of the at least one blade, where the total pressure is below a threshold value, and to estimate an angle of attack of the at least one blade based on a ratio HSS/(HSS+HPS).

15. Use of a sensor according to claim 1 in connection with a wind turbine blade, an aircraft wing, a wing, a blade or an object.

16. A method for estimating an angle of attack of at least one blade, the method comprising:
providing a first sensor according to claim 1 on a pressure side surface of a blade,
providing a second sensor according to claim 1 on a suction side surface of the blade, and
calculating an angle of attack of the blade based on an angle of attack estimator.

17. A non-transitory computer readable medium having stored thereon a set of computer implementable instructions capable of causing a computing device, in connection with a wind turbine, at least to:
receive from a first sensor according to claim 1 information about a stagnation pressure of an incident air flow at different distances from a pressure side surface of a wind turbine blade,
receive from a second sensor according to claim 1 information about a stagnation pressure of an incident air flow at different distances from a suction side surface of the wind turbine blade,
calculate an angle of attack of the wind turbine blade based on an angle of attack estimator, and
control a pitch angle of the wind turbine blade based on the calculated angle of attack.
